(19) United States
(12) Patent Application Publication
(10) Pub. No.: US 2025/0292949 A1
(43) Pub. Date: Sep. 18, 2025

(54) INDUCTIVE COMPONENT, MOLD TOOL AND METHOD FOR EMBEDDING

(71) Applicant: TDK Electronics AG, Muenchen (DE)

(72) Inventors: Fabian Beck, Rüttenen (CH); Anneliese Drespling, Heidenheim (DE); Dirk Beckmann, Königsbronn (DE); Michael Heriadin, Nördlingen (DE)

(21) Appl. No.: 18/861,968

(22) PCT Filed: May 2, 2023
(86) PCT No.: PCT/EP2023/061524

§ 371 Date: Oct. 31, 2024

(30) Foreign Application Priority Data
May 6, 2022 (CN) 102022111353.1

(51) Int. Cl. H01F 27/29; H01F 27/02; H01F 41/00

(52) U.S. Cl. CPC H01F 27/292; H01F 27/022; H01F 41/005

(57) ABSTRACT

In an embodiment an inductive component includes an electrical conductor having a first terminal, a second terminal and a central region, which is electrically arranged between the first terminal and the second terminal, and a body in which the central region is arranged, wherein the central region is centered in the body, and wherein the body has a first one or more outwardly open recesses.

### CROSS-REFERENCE TO RELATED APPLICATIONS

This patent application is a national phase filing under section 371 of PCT/EP2023/061524, filed May 2, 2023, which claims the priority of German patent application 102022111353.1, filed May 6, 2022, each of which is incorporated herein by reference in its entirety.

### TECHNICAL FIELD

The invention relates to inductive components, in particular inductive components with improved magnetic properties, mold tools for manufacturing such components and methods for embedding, e.g. for embedding electrical conductors in a component body.

### BACKGROUND

Inductive components can be used in electrical circuits where they realize inductive circuit elements. The inductances of such components are generally characterized by the shape of an electrical conductor and the magnetic properties of its environment. For example, a coil can be encapsulated in an encapsulation material. The position of the coil in the encapsulation material influences the magnetic and electrical properties of the corresponding component.

For example, inductive elements with a holder for the coil are known from the publications U.S. Pat. No. 9,728,331 B2, U.S. Pat. No. 4,801,912 A or US 2010/0219924 A1. Complex process steps for manufacturing inductive components are known from US 2012/0019343 A1 or US 2009/0250836 A1.

### SUMMARY

Embodiments provide inductive components that can be produced using simple, easy-to-perform manufacturing steps and have precisely adjustable magnetic properties.

The inductive component comprises an electrical conductor. The electrical conductor has a first terminal and a second terminal. Furthermore, the electrical conductor has a central region. The central region is electrically arranged between the first terminal and the second terminal. Further, the inductive component has a body in which the central region is arranged. The central region is centered in the body. Further, the body has a first, outwardly open recess.

The electrical arrangement of the central region between the first terminal and the second terminal essentially means that the electrical conductor is designed in such a way that the central region of the electrical conductor is connected in series between the first terminal and the second terminal. The centering of the central region in the body results in the procession of the central region in the body being fixed with high precision. As a result, the magnetic environment of the central region of the electrical conductor is essentially defined with high precision, so that the electrical and magnetic properties of the inductive component can be set with high precision.

The presence of the outwardly open recess is directly related to high precision adjustable inductance. The outwardly open recess serves to hold the electrical conductor and, in particular, its central region in the intended position during the manufacturing process of the inductive component. Mold materials can then be used to surround the central region, ensuring that the central region is securely fixed even at high mold pressures. The position within the body and thus the thicknesses of the material of the body in the various directions around the central region are thus firmly defined, resulting in the high precision of the adjustability of the electrical and magnetic properties of the inductive component.

The central region of the electrical conductor is essentially the area of the conductor that largely determines the electrical or magnetic properties of the inductive component.

In particular, it is possible for the electrical conductor in the central region to be formed into one or more coils. The electrical conductor can consist of one or more wires or comprise a wire whose corresponding section is formed into windings that produce the coil(s) of the inductive component.

The first terminal and the second terminal of the electrical conductor represent connection options of the inductive component, with which the inductive component can be connected to an external circuit environment. The first terminal and the second terminal can protrude from the body of the inductive component on different sides of the inductive component. However, it is also possible for both terminals to protrude on the same side of the body. This is particularly advantageous if the inductive component is connectable to a printed circuit board using SMD technology (SMD=surface mounted device).

The coil can have essentially circular windings. In particular, the coil can be a cylindrical coil or a planar coil. However, it is also possible for the windings of the coil to have an oval cross-section or a rectangular cross-section.

It is possible that the body of the inductive component, in which the central region is located, contains a mold material or consists of a mold material.

It is also possible for the central region of the electrical conductor to be embedded in the body of the inductive component.

Embedding by means of molding (casting) is an easy way to produce an inductive component. It is possible for the central region and the mold material surrounding the central region to form a monolithic inductive component. The central region of the electrical conductor is essentially in direct contact with the mold material over its entire length.

It is possible that the body contains a second, outwardly open recess, which is arranged opposite the first recess on the body in such a way that the central region is arranged between the first and second recesses.

The significance of the recesses is that during manufacture the associated mold tool has correspondingly shaped elements, e.g. ribs or fins, which hold the central region of the inductive component in position during molding. Ribs of the mold tool can press against the central region of the electrical conductor from different directions, e.g. from opposite directions, and thus hold it in a fixed position with high precision, even if during molding, i.e. during molding with the molding compound, a high mold pressure is required for molding, depending on the mold material.

In particular, the mold tool has a cavity which is intended to be filled by the mold material, wherein the filling of the cavity by the mold material forms the subsequent body in which the electrical conductor with its central region is monolithically enclosed.

The limitation of the cavity of the mold tool on the one hand and the positioning of the central region defined with high precision on the other hand result in an inductive component whose outer dimensions can be precisely adjusted and whose central region of the electrical conductor is determined with high precision so that the magnetic environment of the electrical conductor and in particular of the central region is determined with high precision.

This allows to set the electrical and magnetic properties of the inductive component with a high degree of accuracy, so that an inductive component with precise electrical and magnetic properties is obtained and the inductive component can be manufactured using process steps that are easy to carry out.

It is possible that the inductive component also has further first recesses in the body.

The number of recesses in the body, i.e. the possible positions or directions from which the central region of the electrical conductor can be fixed during encapsulation, determines the precision with which the central region can be set and the mechanical resistance that the central region can offer to the molding compound during encapsulation.

However, the recesses in which the corresponding conductor section of the electrical conductor contains less mold material in its vicinity can be seen as inhomogeneities of the magnetic environment of the inductive component. Therefore, a certain number of recesses and certain positions for the recesses generally result for a certain inductive component, so that the advantageous properties of the recesses outweigh the absence of the corresponding material.

The depths of the recesses and the widths of the recesses are ideally selected so that the necessary mechanical stability when positioning the central region is sufficiently high and the interference with the magnetic environment is sufficiently low.

Accordingly, it is also possible for the inductive component to comprise further second recesses in the body. In this case, the first recesses and second recesses are essentially arranged on opposite sides of the inductive component.

By arranging the recesses or the corresponding ribs opposite each other in the mold tool, the central region can be optimally clamped during production so that the central region is optimally fixed during the application of the mold material.

It is possible for the recesses to have a width B of 0.1 mm≤B≤mm.

Accordingly, it is possible for the recesses to have a depth T of 0.05 mm≤T≤1.0 mm.

It is possible for the body of the inductive component to have an essentially cuboid shape. The essentially cuboid body can have edge lengths K1, K2, K3 of 0.2 mm or more and 5 mm or less.

Except for the terminals, the body can have a shape that corresponds exactly to a cuboid shape. However, it is often advantageous if the exact shape of the body deviates slightly from a cuboid shape. For example, the edges of the cuboid can each have a chamfer. Further, the body can have a side surface that is asymmetrical to other side surfaces of the body in order to make it easier to orient the component, e.g. when connecting it to a printed circuit board.

Accordingly, it is possible that the inductive component is an SMD element.

For this purpose, it is possible that the terminals of the inductive component protrude from the body of the component with a certain length that is suitable for mechanically and electrically connecting the body to conductor structures on a printed circuit board. In particular, the surfaces of the terminals can be wetted with a solderable material.

It is possible for the electrical conductor to have an inductance I, wherein the inductance I can be ≥5 nH and ≤100 pH.

It is possible for the inductive element to have an upper side and a lower side, with the lower side being opposite the one described above. The component can have four recesses on the upper side and two recesses on the lower side. In particular, the four recesses on the upper side can each be arranged on one side of an essentially rectangular base surface.

Accordingly, it is also preferable if the two recesses on the lower side are arranged on opposite sides of the essentially cuboid body.

It is possible that the body has a magnetic permeability P, where the magnetic permeability P is greater than or equal to 2 H/m and less than or equal to 100 H/m.

It is possible that the body of the inductive component comprises a plastic, wherein the plastic is filled with a magnetic material.

Materials such as ferrites or iron alloys can be considered as materials for the magnetic material, which is mixed into the plastic matrix as a filler.

If the body comprises a mold material, the mold material may comprise or consist of a synthetic resin, e.g. an epoxy.

It is possible that the electrical conductor comprises or consists of a material selected from copper (Cu), silver (Ag), gold (Au) and aluminum (Al).

At least one section of the electrical conductor can be visible through the recess in the central region.

A corresponding mold tool for manufacturing an inductive component as described above can comprise an access and a rib.

The access serves as an opening for adding the mold material during the manufacturing process. The rib serves as a support and for fixing the central region of the electrical conductor so that it is arranged with high precision in its intended position on the finished component.

It is also possible for the mold tool to have a lower part and an upper part. The lower part can have two ribs and the upper part can have four ribs-or vice versa. The ribs serve to hold the central region in position during molding and are later revealed as the recesses in the finished inductive component.

Further, the mold tool can have side walls which have a cavity in which the central region of the conductor can be arranged, wherein the side walls define the later outer surfaces of the later component.

A method for centered embedding of a central region of an electrical conductor can comprise the steps:
providing a mold tool with an access and a rib,
providing the electrical conductor,
positioning the central region on the rib,
enclosing the central region by pressing a mold material through the access.

The mold mass can form a body in which the central region of the electrical conductor is enclosed, wherein the mold mass does not occupy a volume of the rib, so that a recess is formed in the body at the position of the rib.

By using the described mold tool and by applying the steps of the described method, an inductive component is obtained whose central region of the electrical conductor is centered with high precision so that precisely defined material thicknesses are obtained on the side walls between the central region and the outer surfaces of the body. This results in an easy-to-produce inductive component with precisely defined electrical and magnetic properties.

### BRIEF DESCRIPTION OF THE DRAWINGS

Operating principles and details of preferred embodiments are explained in more detail with reference to the schematic figures.

FIG. 1 shows a perspective view of an inductive component;

FIG. 2 shows a perspective view of the lower side of the component;

FIG. 3 shows a perspective view of the electrical conductor arranged in the body of the component;

FIG. 4 shows a cut-away body of an inductive component indicating the position of the electrical conductor;

FIGS. 5 and 6 show perspective views of the position of the electrical conductor inside the body, shown from different directions;

FIGS. 7 to 10 show side views of an inductive component with size indications of a preferred embodiment;

FIG. 11 shows a perspective view of a mold tool with access points for applying the mold material; and

FIG. 12 shows a cross-section through the arrangement of mold tool and mold material with size indications of a preferred embodiment.

### DETAILED DESCRIPTION OF ILLUSTRATIVE EMBODIMENTS

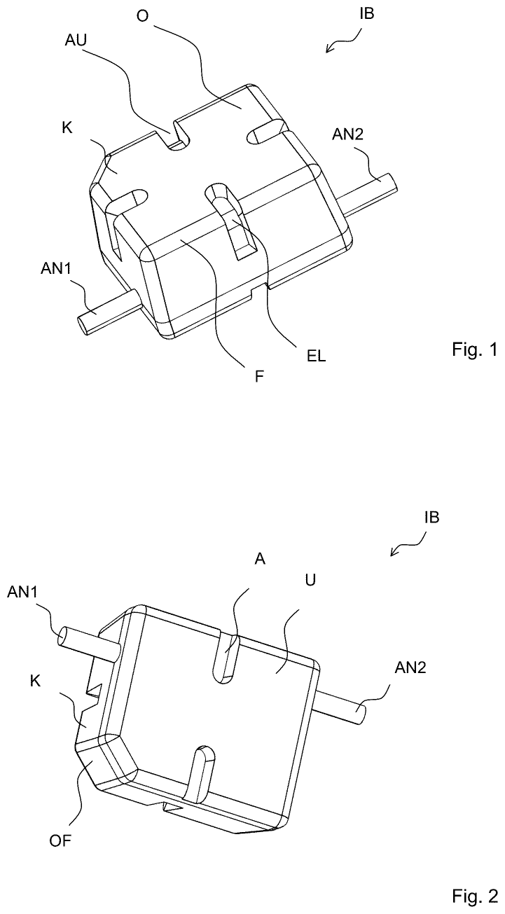

FIG. 1 shows a perspective view of an inductive component IB with a body K and a first terminal AN1 and a second terminal AN2. The body K has an essentially cuboid shape and an upper side O. Four recesses AU are arranged on the upper side O, the recesses AU being arranged on the four edges of the surface in such a way that two recesses AU are located opposite each other. In the perspective view, it can be seen that a recess is also arranged on the lower side, at least on the side surface facing the viewer in the perspective view.

The terminals AN1, AN2 are located on opposite sides of the essentially cuboid body K. The central region is arranged between them, from which at least one section of the electrical conductor EL is visible through the recess AU.

The essentially cuboid body K has a chamfer F on its edges. This chamfered surface reduces burrs and can simplify further assembly.

FIG. 2 shows a perspective view of the inductive component IB with the lower side U facing the observer. It can also be seen that the essentially cuboid body K has an orientation surface OF instead of an edge, the orientation surface OF simplifying the orientation of the component IB due to the symmetry breaking.

On the lower side U of the component IB, there are two recesses A on opposite sides of the essentially cuboid base body K.

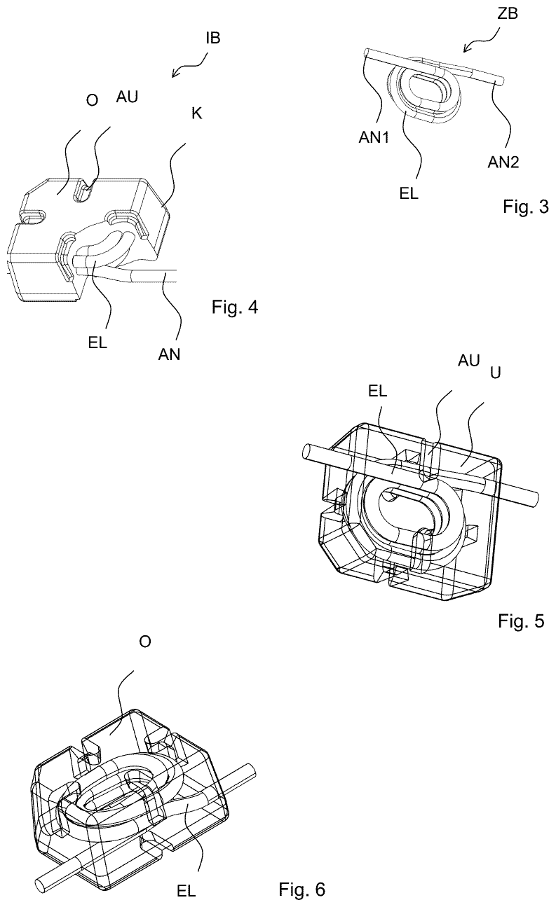

FIG. 3 shows a perspective view of the electrical conductor EL, in which the central region ZB contains windings of a coil that are electrically connected in series between the first terminal AN1 and the second terminal AN2. The terminals AN1, AN2 are used to connect the inductive component to an external circuit environment. The shape of the conductor EL in the central region ZB essentially determines the electrical and magnetic properties of the inductive component.

FIG. 4 shows a perspective view of an inductive component IB with a section through the body K, so that the position of the electrical conductor inside the body K is recognizable.

FIGS. 5 and 6 in turn show the complete position of the electrical conductor EL inside the inductive component and the corresponding positions of the recesses from different viewing directions. For example, the observer looks at the lower side of the component in FIG. 5 and at the upper side O of the component in FIG. 6.

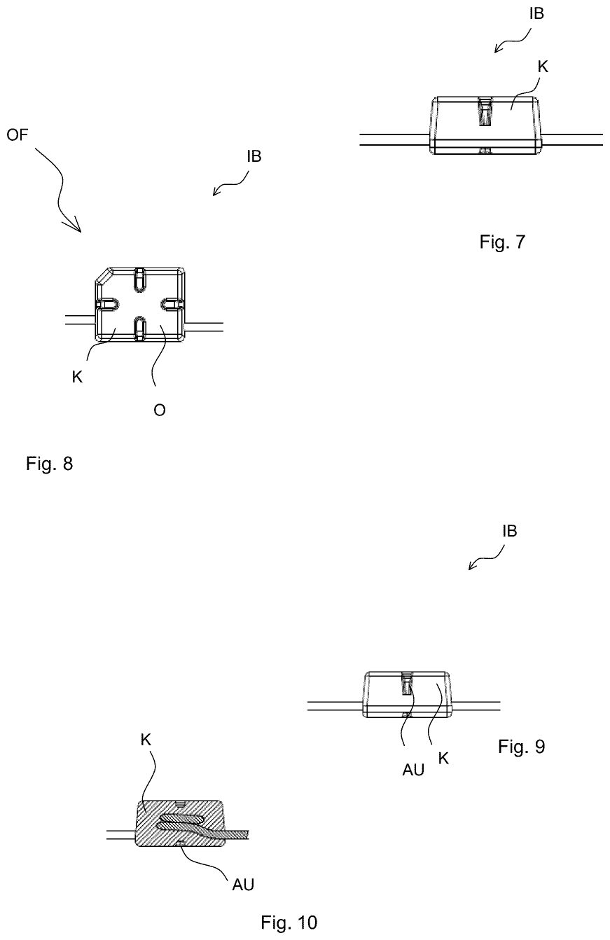

FIG. 7 shows a side view of an inductive component with a total height in the vertical direction of the component of 1 mm, wherein the actual height can vary by 0.03 mm.

FIG. 8 shows a corresponding component in a top view, wherein the component has a length of 2+0.03 mm and the component has a width of 1.65+0.03 mm. The orientation surface has an edge which is 0.3 mm away from the associated side wall of the component, wherein the orientation surface together with a side surface encloses an angle of 45°.

FIG. 9 shows a possible dimensioning of the recesses on the upper side. Four recesses can be provided, with each recess on the upper side having a width of 0.2+0.02 mm.

FIG. 10 shows the possible dimensions of a recess on the lower side. There are two recesses on the lower side, which also have a width of 0.2+0.02 mm.

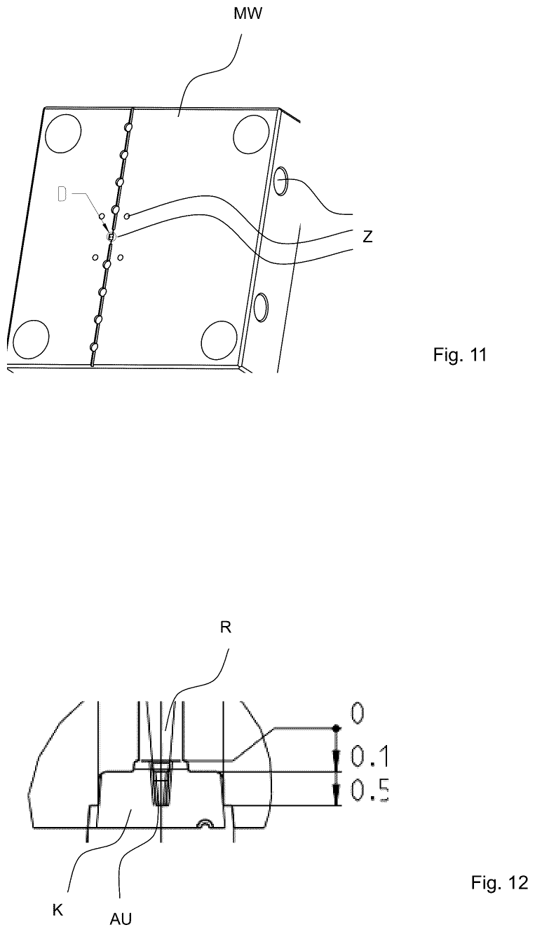

FIG. 11 shows a perspective view of a mold tool MW, which has accesses Z that are designed as holes. The potting compound can be pressed into the cavity behind it with an appropriate pressure via the openings Z so that the cavity is completely filled without the central region of the electrical conductor being pushed away from its preferred position.

FIG. 12 shows a cross-section and the presence of the rib R during molding, which holds the central region in place and at whose position the later recess will be positioned, since the mold compound cannot occupy the volume of the rib R.

1.-21. (canceled)

22. An inductive component comprising:
an electrical conductor having a first terminal, a second terminal and a central region, which is electrically arranged between the first terminal and the second terminal; and
a body in which the central region is arranged,
wherein the central region is centered in the body,
wherein the body has a first one or more outwardly open recesses.

23. The inductive component according to claim 22, wherein the conductor in the central region comprises one or more coils.

24. The inductive component according to claim 22, wherein the body comprises a mold material or consists of a mold material.

25. The inductive component according to claim 22, wherein the central region is embedded in the body.

26. The inductive component according to claim 22, wherein the body comprises one or more second outwardly open recesses arranged opposite the first recesses on the body such that the central region is arranged between the first and second recesses.

27. The inductive component according to claim 22, further comprising further first recesses in the body.

28. The inductive component according to claim 22, further comprising further second recesses in the body, wherein first and second recesses are respectively arranged on opposite sides of the body.

29. The inductive component according to claim 22, wherein the first recesses have a width B, where 0.1 mm≤B≤1.0 mm.

30. The inductive component according to claim 22, wherein the recesses have a depth T, where 0.05 mm≤T≤1.0 mm.

31. The inductive component according to claim 22, wherein the body has a substantially cuboidal shape with edge lengths K1, K2, K3, where 0.2 mm≤K1, K2, K3≤5 mm.

32. The inductive component according to claim 22, wherein the inductive component is an SMD element.

33. The inductive component according to claim 22, wherein the electrical conductor has an inductance I, where 5 nH≤I≤100 μH.

34. The inductive component according to claim 22, wherein the inductive component has an upper side and an opposite lower side, and wherein 1, 2, 3 or 4 recesses are located on the upper side and 1, 2, 3 or 4 recesses are located on the lower side.

35. The inductive component according to claim 22, wherein the body has a magnetic permeability P, where 2 H/m≤P≤100 H/m.

36. The inductive component according to claim 22, wherein the body comprises a plastic filled with a magnetic material.

37. The inductive component according to claim 22, wherein the electrical conductor comprises or consists of a material selected from Cu, Ag, Au, or Al.

38. The inductive component according to claim 22, wherein at least one section of the electrical conductor is visible through the recesses in the central region.

39. The inductive component according to claim 22, wherein at least one recess extends from an upper side of the body to a side surface of the body, which is perpendicular to the upper side.

40. The inductive component according to claim 22, wherein the body comprises an orientation surface, which generates a symmetry breaking of an otherwise cuboid shape.

41. The inductive component according to claim 22, wherein four recesses are arranged on an upper side of the body, wherein the recesses are arranged on four edges of the upper side in such a way that two recesses are located opposite each other, respectively.

42. A mold tool for manufacturing the inductive component according to claim 22, the mold tool comprising:
an access and a rib.

43. The mold tool according to claim 42, further comprising:
a lower part;
an upper part;
1, 2, 3 or 4 ribs on the lower part; and
1, 2, 3 or 4 ribs on the upper part.

44. A method for embedding a central portion of an electrical conductor, the method comprising:
providing a mold tool with an access and a rib;
providing the electrical conductor;
positioning the central portion on the rib; and
enclosing the central portion by pressing a mold material through the access.

45. The method according to claim 44, wherein a mold mass forms a body in which a central region of the electrical conductor is enclosed, wherein the mold mass does not occupy a volume of the rib so that a recess is formed in the body at a position of the rib.
